(19) United States
(12) Patent Application Publication
(10) Pub. No.: US 2013/0050398 A1
(43) Pub. Date: Feb. 28, 2013

(54) SYSTEM AND METHOD FOR COLLABORATOR REPRESENTATION IN A NETWORK ENVIRONMENT

(71) Applicants: Pär-Erik KRANS, Drammen (NO); Fredrik E. M. Oledal, Oslo (NO); Norma Løvhaugen, Asker (NO); Johan Ludvig Nielsen, Oslo (NO); Lasse S. Thoresen, Oslo (NO); Dan Peder Eriksen, Oslo (NO)

(72) Inventors: Pär-Erik KRANS, Drammen (NO); Fredrik E. M. Oledal, Oslo (NO); Norma Løvhaugen, Asker (NO); Johan Ludvig Nielsen, Oslo (NO); Lasse S. Thoresen, Oslo (NO); Dan Peder Eriksen, Oslo (NO)

(73) Assignee: Cisco Technology, Inc.

(21) Appl. No.: 13/595,689

(22) Filed: Aug. 27, 2012

Related U.S. Application Data
(60) Provisional application No. 61/532,874, filed on Sep. 9, 2011.

(30) Foreign Application Priority Data
Aug. 31, 2011 (NO) 2011158

(51) Int. Cl. H04N 7/14

(52) U.S. Cl. 348/14.07; 348/14.08; 348/E07.083

(57) ABSTRACT

A method is provided in one example embodiment and can include displaying a first image signal on a screen and capturing an object in front of the screen in a captured object/image signal. The method may further include generating an object signal by removing the first image signal from the object/image signal, where the object signal is a representation of the object captured in front of the screen.

### CROSS-REFERENCE TO RELATED APPLICATIONS

This application claims the benefit of priority under 35 U.S.C. §119(e)/§120 to U.S. Provisional Application Ser. No. 61/532,874, “VIDEO CONFERENCE SYSTEM” filed Sep. 9, 2011 and also claims priority to Norwegian Patent Application Serial No. 20111185 “VIDEO ECHO CANCELLATION” filed Aug. 31, 2011, both of which are hereby incorporated by reference in their entireties.

### TECHNICAL FIELD

This disclosure relates in general to the field of communications and, more particularly, to a collaborator representation in a network environment.

### BACKGROUND

Video services have become increasingly important in today's society. In certain architectures, service providers may seek to offer sophisticated video conferencing services for their participants. The video conferencing architecture can offer an “in-person” meeting experience over a network. Video conferencing architectures can deliver real-time, face-to-face interactions between people using advanced visual, audio, and collaboration technologies. The ability to optimize video communications provides a significant challenge to system designers, device manufacturers, and service providers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for collaborator representation in a network environment in accordance with one example embodiment of the present disclosure;

FIG. 1B is a simplified block diagram in accordance with another embodiment of the present disclosure;

FIG. 2 is a simplified block diagram in accordance with another embodiment of the present disclosure;

FIG. 3A is a simplified schematic diagram in accordance with another embodiment of the present disclosure;

FIG. 3B is a simplified block diagram in accordance with another embodiment of the present disclosure;

FIG. 4A is a simplified block diagram in accordance with another embodiment of the present disclosure;

FIG. 4B is a simplified block diagram in accordance with another embodiment of the present disclosure;

FIG. 4C is a simplified block diagram in accordance with another embodiment of the present disclosure;

FIG. 5A is a simplified block diagram in accordance with another embodiment of the present disclosure;

FIG. 5B is a simplified block diagram in accordance with another embodiment of the present disclosure;

FIG. 6 is a simplified flowchart illustrating potential operations associated with the present disclosure; and

FIG. 7 is another simplified flowchart illustrating potential operations associated with the present disclosure.

### DETAILED DESCRIPTION OF EXAMPLE EMBODIMENTS

### Overview

A method is provided in one example embodiment and can include displaying a first image signal on a screen and capturing an object in front of the screen in a captured object/image signal. The method may further include generating an object signal by removing the first image signal from the object/image signal, where the object signal is a representation of the object captured in front of the screen.

In one example implementation, the object signal may be generated by respectively inserting pixel values of the first image signal in corresponding pixel positions of the object/image signal, where a difference between the pixel values of the first image signal and the corresponding pixel positions of the object/image signal are below a threshold. The method may also include spatially aligning the first image signal and the object/image signal by associating pixel positions of the first image signal and the object/image signal. In one specific instance, the method may include assigning a gradient to the representation of the object in the object signal, where the gradient is based on a calculated distance from the object to the screen.

In other implementations, the screen is a first video conference screen and the method may include sending the object signal to a second video conference screen that is remote from the first video conference screen. The method may also include combining the object signal and the first image signal to create a remote object/image signal and displaying the remote object/image signal on the second video conference screen. Further, the method may include receiving a second object signal, combining the second object signal to the remote object/image signal to create a second remote object/image signal, and displaying the second remote object/image signal on the second video conference screen. In a specific embodiment, the first image signal is a non-mirrored representation of collaboration material and the object is a collaborator interacting with the first image.

### Example Embodiments

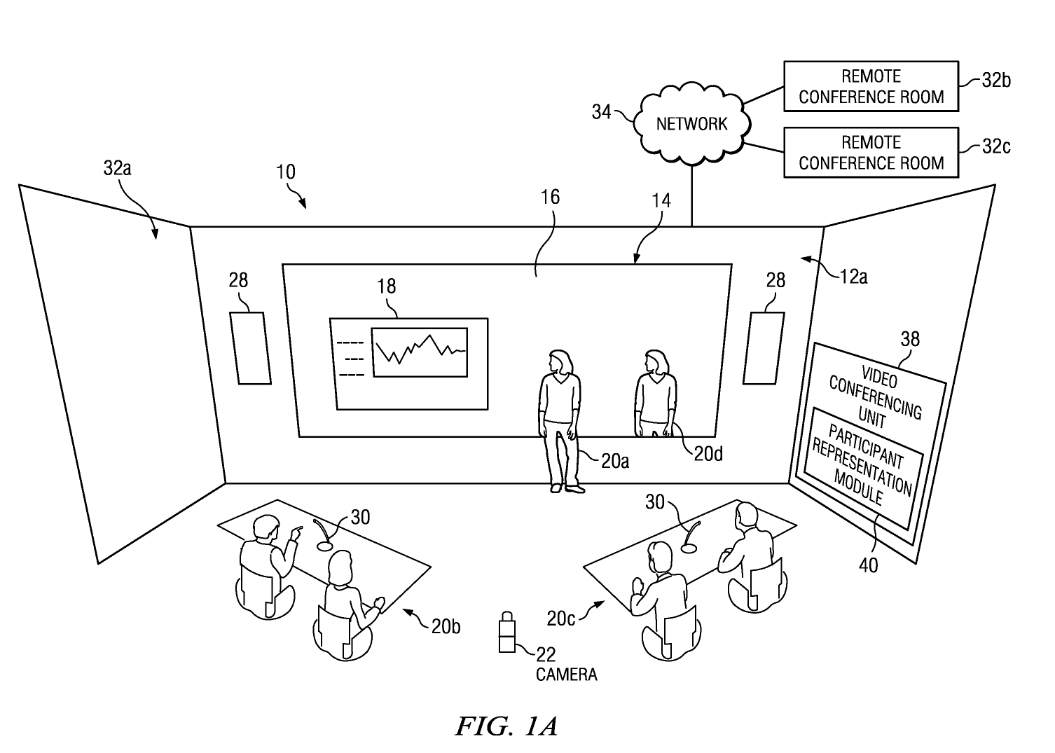

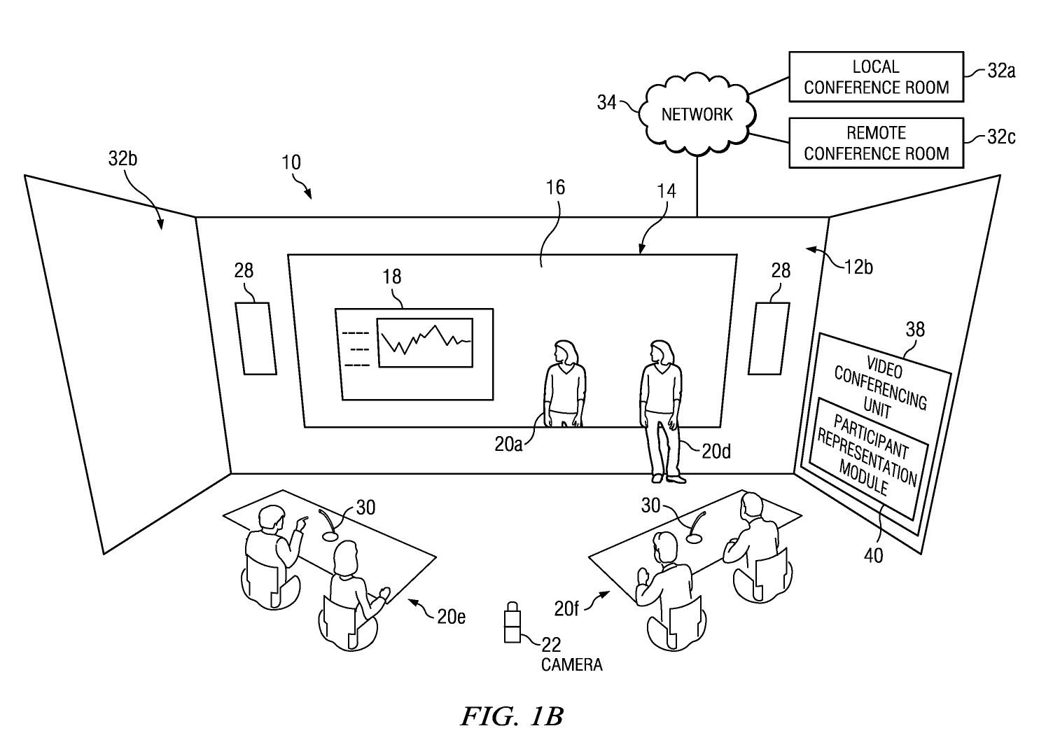

Turning to FIG. 1A, FIG. 1A is a simplified block diagram of a collaboration system 10 for providing a collaborator representation in a network environment in accordance with one embodiment of the present disclosure. Collaboration system 10 includes a local conference room 32a, remote conference rooms 32b and 32c, and a network 34. Local conference room 32a includes a presentation area 12a, a display screen 14, a collaborator 20a, and a set of participants 20b and 20c. Note that reference number 20 is used to represent both a collaborator and a participant because a participant in presentation area 12a could equally be a collaborator. Collaboration system 10 can also include a camera 22, a plurality of speakers 28 (in an embodiment, only one speaker 28 may be present), a plurality of microphones 30 (in an embodiment, only one microphone 30 may be present), and a video conferencing unit 38. Display screen 14 includes an image 16. Image 16 includes presentation material 18 and collaborator 20d. Video conferencing unit 38 includes a participant presentation module 40.

Video conferencing unit 38 is configured to display image 16, presentation material 18, and one or more collaborators (e.g., collaborator 20d) on display screen 14. Presentation material 18 can be a representation of content or collaboration material on which collaborator 20a and 20d are working. Collaborators 20a and 20d can each be a single collaborator (as shown) or multiple collaborators. Each participant 20b and 20c can be a single participant or a plurality of participants. In one example, in addition to being an endpoint, video conferencing unit 38 may contain a multipoint control unit (MCU) or may be configured to communicate with a MCU.

Collaboration system 10 can be configured to capture one or more collaborators sharing presentation material 18 by having camera 22 capture a video of presentation area 12a and then extract each collaborator from the captured video using signal processing. Shading and/or blending of each collaborator (e.g., according to the distance each collaborator is from display screen 14) can be used to indicate the grade of presence. After each collaborator has been removed from the captured video, and shaded and/or blended, an image of each collaborator can be sent to other sites (e.g., remote conference rooms 32b and 32c). In one example implementation, the capturing and reproducing of collaborators can create a virtual presentation area (e.g., presentation area 12a) in front of display screen 14, which can be shared between conference sites. Each conference site may add a new layer to the presentation area to facilitate a natural sharing of an image (e.g., image 16) on a physical display. As a result, each participant and collaborator can see who is in a presentation area at each conference site and the presentation activities, thus making it easy to avoid collisions in virtual space. Using speakers 28, the sound system can be directional, with sound coming from the direction of the image to support the representation of the collaborators. Collaboration system 10 can be configured to enable local and remote collaborators to work together and can scale from one local meeting site to multiple sites.

Turning to FIG. 1B, 1B is a block diagram illustrating additional details associated with collaboration system 10. Collaboration system 10 includes local conference room 32a, remote conference rooms 32b and 32c, and network 34. Remote conference room 32b includes presentation area 12b, display screen 14, collaborator 20d, participants 20e and 20f, camera 22, speakers 28, microphone 30, and video conferencing unit 38. Display screen 14 includes image 16. Image 16 includes presentation material 18, and collaborator 20a (from local conference room 32a). Video conferencing unit 38 includes participant presentation module 40.

Video conferencing unit 38 is configured to display image 16, presentation material 18, and one or more collaborators (e.g., collaborator 20a) on display screen 14. Presentation material 18 may be a representation of content or collaboration material on which collaborators 20a and 20d are working. Each participant 20e and 20f could be a single participant or a plurality of participants.

In one particular example, collaboration system 10 can be configured to display a first image signal on display screen 14 and capture, by camera 22, at least a part of presentation area 12b and at least a part of an object or collaborator (e.g., collaborator 20d) in presentation area 12b, resulting in a captured image signal. Collaboration system 10 may further be configured to calculate a difference image signal between the first image signal and the captured signal to generate a second image signal by respectively inserting pixel values of the first image signal in the corresponding pixel positions of the difference image signal where the pixel values of the difference image signal are below a threshold. The difference image signal may then be used to create a presence area in front of a collaboration wall surface (e.g., display screen 14), which can be shared between presentation sites. This allows collaborator 20a and participants 20b and 20c at local conference room 32a and collaborator 20d and participants 20e and 20f at remote conference room 32b can interact with presentation material 18 as if they were in the same room.

For purposes of illustrating certain example techniques of collaboration system 10, it is important to understand the communications that may be traversing the network. The following foundational information may be viewed as a basis from which the present disclosure may be properly explained. Videoconferencing allows two or more locations to interact via simultaneous two-way video and audio transmissions. The usability of systems for video conferencing and Telepresence needs to be able to serve multiple purposes such as connect separate locations by high quality two-way video and audio links, share presentations and other graphic material (static graphics or film) with accompanying audio, provide a means for live collaboration between participants in the separate locations, etc. Many videoconferencing systems comprise a number of end-points communicating real-time video, audio and/or data (often referred to as duo video) streams over and between various networks such as WAN, LAN and circuit switched networks. A number of videoconference systems residing at different sites may participate in the same conference, most often, through one or more MCUs performing switching and mixing functions to allow the audiovisual terminals to intercommunicate properly.

Video conferencing systems presently provide communication between at least two locations for allowing a video conference among participants situated at each conference location. Typically, the video conferencing arrangements are provided with one or more cameras. The outputs of those cameras are transmitted along with audio signals to a corresponding display or a plurality of displays at a second location such that the participants at the first location are perceived to be present or face-to-face with participants at the second location. Video conferencing and Telepresence is rapidly growing. New functions are steadily creeping in and the video resolution and the size of the screens tend to increase. To maximize the usability of systems for video conferencing and Telepresence, they need to be able to serve multiple purposes. For example, connect separated locations by high quality two-way video and audio links, share presentations and other graphic material (static graphics or film) with accompanying audio, provide means for live collaboration between collaborators in the separate locations, provide an understandable representation of participants working on collaboration material, etc.

However, a natural and/or intuitively understandable representation of the collaborators working close to (or on) the collaboration screen is a major challenge, as these collaborators often are the center of focus in the interaction. Further, only capturing (and relying on) data from the camera and the microphone can be challenging as collaborators move in their space. In addition to any collaborators, the camera can also capture the content and material on the screen that is already represented separately. In addition, even if the capturing is done well, reproduction on remote sites can ultimately be confusing to the audience.

Solutions using a separate video stream can often reduce the feeling of presence for remote participants. For example, collaborators and participants can feel trapped between a mirrored representation of collaborators looking at each other through a virtual transparent boundary and the non-mirrored representation of content and collaboration material on which they are working. Thus, there is a need for a solution for capturing and representing the collaborators sharing a collaboration surface in an intuitively understandable way. Any solution should combine and represent the different elements (collaborators, participants, content, collaboration material) together in one meaningful, comprehensive, and dynamic fashion and organize the multi-purpose screen space to optimize the feeling of presence, while keeping an overview over all meeting participants in a multi-site situation.

The representation of collaborators from a separate location can be done by capturing a video image with a camera, mirroring the image, and reproducing the image on a screen locally. The display is like looking through a transparent boundary into the other room. The same applies to multi-channel audio captured by a microphone system. Connecting multiple rooms and/or sites is often required and as a result, the layout of the reproduction quickly becomes a challenge, especially with multiple sites with many collaborators in each site. The representation of a presentation (documents, pre-produced graphics material or film) can be presented equally (e.g., non-mirrored) in all sites. Accompanying multi-channel audio may also be presented equally in all sites.

For collaboration over video conferencing and Telepresence, virtually sharing a collaboration device across the sites involved is essential. For instance, the collaboration device may be a video screen which can show the same content in both rooms and provide means for pointing and annotation, for instance by having touch functionality. In an embodiment, the material on the collaboration device, (e.g., presentation material 18), can be represented as non-mirrored.

In accordance with one example implementation, collaboration system 10 can process a captured image so as to overlay and blend collaborators on top of a presentation or collaboration video. In one example implementation, a camera (e.g., camera 22) in the back of the room may be used to capture a scene that includes a presentation area (e.g., presentation area 12a). Collaborators working on a display screen with collaboration material can be extracted by video signal processing. In addition, shading or blending of the collaborators according to the distance from the display screen may be used to indicate a grade of presence. The collaborators may then be projected or inserted into a video stream that is sent to other conference sites. As a result, the presentation area in front of the display screen may be created and shared between all the conference sites. Each presentation area from each site may be stack on top of the other presentation areas (e.g., presentation area 12a may be stacked on top of presentation are 12b) and the content on the screen can be non-mirrored to allow for natural collaboration.

In a room with multiple collaborators, it is naturally easy to perceive the grade of involvement or presence of each collaborator in the room. However, in the context of video, it is harder to fully appreciate the grade of involvement or presence of each collaborator. One solution to the grade of presence problem is to overlay and blend collaborators on top of a presentation or collaboration video. The degree of blending can be used to simulate the grade of presence. For example, a collaborator in close interaction to a presentation can be shown fully visible. In contrast, a collaborator standing away from a presentation can be shown as a transparent or an outlined figure, similar to a ghost image in sports events or racing video games.

To accomplish blending that is correlated with the collaborator's position, a collaborator positioning system can be used to control the grade of blending. To capture the collaborators, there can be one or several cameras together or in different positions. In addition to the camera (or cameras), there can be extra sensors to aid in identification of the positions of the collaborators. For instance, a 3D-camera (e.g., Microsoft Kinect) that measures the geometry of the room and collaborators may be used. Other methods can also be used for this task, for example push sensitive carpets or IR sensors that detect only the collaborator in front of the display screen.

In one example implementation, the camera may capture the presentation area and the local collaborator. Because the display screen includes presentation or collaboration material that is the same for all conference locations, a collaborator can be extracted from the captured video (using any suitable image processing method) to create a video of only the collaborator. When the video of the collaborator has been extracted, it can be mixed into the collaboration video stream, or sent separately to the remote conference locations, where each site can compose their own layout. For standard endpoints, the layout can be done at a master site. For a smaller multipurpose system with annotation possibilities (traditional mouse or touch input), the collaborator (or site) can be represented by a virtual hand with a written signature. If a directional audio system is present, standard endpoints can also be audio positioned. In a multipoint call, dependent on the endpoint capabilities and settings, a MCU can control the layout, or just send the streams on. Both mix-minus and switching paradigms can be used.

In case of perfect pixel-to-pixel alignment between the camera and a background video (e.g., image 16), pixel-to-pixel, a difference image signal between those streams can be calculated:

P(x,y)diff=P(x,y)camera−P(x,y)background

P(x,y)background is the known image signal displayed on the wall (e.g., image 16). P(x,y)camera is the camera captured image signal and can include a collaborator. All the image signals contain spatial pixels, where the pixel positions are defined by the x and y coordinates.

In case of non-perfect alignment, a transformation may need to be done to achieve spatial pixel-to-pixel match in the subtraction. This spatial alignment of the known image signal and the camera captured image signal can be done by associating the pixel positions in the respective signals in a way that provides an overall match between the pixel values of the respective signals. From the camera captured image signal, a transformation can also bring a non-rectangular camera stream to the same resolution, size and ratio as the background stream. With this transformation, a pixel-to-pixel image can be created by re-sampling the camera stream.

The robustness of the system may be improved by checking for a correlation of P(x,y)diff with surrounding pixels. Depending on the quality of the camera stream, there can be some noise/offset left in the P(x,y)diff signal. This may appear as a shadow of the wall background in the P(x,y)diff image since the wall background captured by the camera and the known background image is not exactly the same. However, provided that the above-mentioned pixel-to-pixel match has been achieved, the P(x,y)diff in background area positions are significantly lower than in the area covered by collaborators. The noise/offset can therefore be eliminated or reduced by setting pixel values of P(x,y)diff, which is below a certain threshold (T) to zero. The threshold can depend on characteristics of the camera and/or the screen, the light conditions in the room and/or the position an angle of the camera in relation with the screen. For example:

P′(x,y)diff=P(x,y)camera−P(x,y)background−N(x,y)

N(x,y)=P(x,y)diff when P(x,y)diff<T

N(x,y)=0 when P(x,y)diff>=T

This can make P′(x,y)diff to include an extract of the captured participants from the background. The resulting second image signal to be displayed on the far end side is then

P(x,y)=P′(x,y)diff+P(x,y)background

P(x,y)=P(x,y)camera−N(x,y)

Correspondingly, instead of introducing the modified difference image signal P′(x,y)diff, P(x,y) may also be generated directly from P(x,y)diff and P(x,y) background. This may be achieved by defining the pixels of P(x,y) in corresponding pixel positions to be equal to P(x,y) background, where the pixel values of P(x,y)diff are below T and defining the pixels of P(x,y) in corresponding pixel positions to be equal P(x,y)diff, and where the pixel values of P(x,y)diff are equal to or larger than T. This can also correspond to inserting P(x,y) background into P(x,y)diff where P(x,y)diff are below T. Mathematically, this can all correspond to introducing the modified difference image signal P′(x,y)diff, and therefore, may be used in the following sets of equations.

In one example, conference site A (e.g., local conference room 32a) and conference site B (e.g., remote conference room 32b) are participating in a video conference with a presenter in front of the image wall at each conference site (i.e., two presenters at two different conference sites). Hence, there can then be two different sets of equations:

PA(x,y)diff=P(x,y)background−PA(x,y)camera

P′A(x,y)diff=PA(x,y)camera−P(x,y)background−NA(x,y)

NA(x,y)=PA(x,y)diff when PA(x,y)diff<TA

NA(x,y)=0 when PA(x,y)diff>=TA

PA(x,y)=P′A(x,y)diff+P(x,y)background

PB(x,y)diff=P(x,y)background−PB(x,y)camera

P′B(x,y)diff=PB(x,y)camera−P(x,y)background−NB(x,y)

NB(x,y)=PB(x,y)diff when PB(x,y)diff<TB

NB(x,y)=0 when PB(x,y)diff>=TB

PB(x,y)=P′B(x,y)diff+P(x,y)background

PA(x,y)camera is the image captured on site A, and PB(x,y)camera is the image captured at site B. P(x,y)background is the presentation image shared at both sites. PA(x,y) can, in this case, constitute the image at site B, and consequently represent the background captured by the camera at site B. Likewise, PB(x,y) can constitute the image at site A, and consequently represent the background captured by the camera at site A. It follows from the equations above that this also can be expressed as:

P′B(x,y)diff=PB(x,y)camera−PA(x,y)camera+NA(x,y)−NB(x,y)

The resulting image to be displayed on the display screen at the far end side relative to B is then:

PB(x,y)=PB(x,y)camera−PA(x,y)camera+NA(x,y)−NB(x,y)+P(x,y)background

PA(x,y)can be derived accordingly:

PA(x,y)=PA(x,y)camera−PB(x,y)camera+NB(x,y)−NA(x,y)+P(x,y)background

PB(x,y) could be generated at site B and transmitted to site A, provided that PA(x,y)camera is available at site B, or it could be generated at site A provided that PB(x,y)camera is available at site A. The same is the case for PB(x,y), but in opposite terms.

The process and equations can be added up when more sites with collaborators located in the presentation area participate in the conference with the same video conference arrangement. Collaborators are not limited to being located in front of the display screen only at the near end side. This framework is also applicable to multi-site conferences (i.e., video conferences with three or more sites participating) with one or more collaborators located in front of the display screen in at least two sites.

Collaboration system 10 can also be configured for tracking the distance between collaborators and the display screen. In one example, in addition to capturing the collaborator, the camera can also capture the floor behind the collaborator. Tracking of the feet position related to a lower edge of the camera picture reveals the distance to the display screen. In one instance, only the floor area that is set as the presentation area is within the camera field. Participants with their feet fully within this area can be identified as collaborators and thus fully visible in the collaboration act.

In yet another example, triangulating with two cameras may be used. Knowing the distance between cameras and distance to the display screen makes triangulation possible. The two camera pictures are compared and the shadow the collaborator casts on the wall can be used as reference. Other examples for tracking the distance between collaborators and the display screen include an angled mirror in the ceiling to reflect a top view to the camera in order to target collaborators, a 3D-camera (e.g., Microsoft Kinect) positioned beside a normal camera, a push sensitive carpet that can detect where a collaborator is located based on the pressure from the collaborator's feet, etc.

The solutions for capturing and reproducing collaborators can create a presentation area in front of the display screen that is shared between all the conference locations. The presentation areas from all the conference locations can stack on top of each other to provide for natural sharing of a display screen, as it can be easy to see who is in the presentation area with no collisions in virtual space.

Turning to the example infrastructure associated with present disclosure, presentation area 12a offers a screen (e.g., display screen 14) on which video data can be rendered for the participants. Note that as used herein in this Specification, the term ‘display’ is meant to connote any element that is capable of delivering image data (inclusive of video information), text, sound, audiovisual data, etc. to participants. This would necessarily be inclusive of any screen-cubes, panel, plasma element, television (which may be high-definition), monitor or monitors, computer interface, screen, Telepresence devices (inclusive of Telepresence boards, panels, screens, surfaces, etc.), or any other suitable element that is capable of delivering/rendering/projecting (from front or back) such information. In an embodiment, presentation area 12a is equipped with a multi-touch system for collaboration.

Network 34 represents a series of points or nodes of interconnected communication paths for receiving and transmitting packets of information that propagate through collaboration system 10. Network 34 offers a communicative interface between local conference room 32a and one or both remote conference rooms 32b and 32c, and may be any local area network (LAN), wireless local area network (WLAN), metropolitan area network (MAN), wide area network (WAN), VPN, Intranet, Extranet, or any other appropriate architecture or system that facilitates communications in a network environment.

Camera 22 is a video camera configured to capture, record, maintain, cache, receive, and/or transmit image data. The captured/recorded image data could be stored in some suitable storage area (e.g., a database, a server, video conferencing unit 38, etc.). In one particular instance, camera 22 can be a separate network element and have a separate IP address. Camera 22 could include a wireless camera, a high-definition camera, or any other suitable camera device configured to capture image data.

Video conferencing unit 38 is configured to receive information from camera 22. Video conferencing unit 38 may also be configured to control compression activities or additional processing associated with data received from camera 22. Alternatively, an actual integrated device can perform this additional processing before image data is sent to its next intended destination. Video conferencing unit 38 can also be configured to store, aggregate, process, export, or otherwise maintain image data and logs in any appropriate format, where these activities can involve a processor and a memory element. Video conferencing unit 38 can include a video element that facilitates data flows between endpoints and a given network. As used herein in this Specification, the term ‘video element’ is meant to encompass servers, proprietary boxes, network appliances, set-top boxes, or other suitable device, component, element, or object operable to exchange video information with camera 22.

Video conferencing unit 38 may interface with camera 22 through a wireless connection or via one or more cables or wires that allow for the propagation of signals between these elements. These devices can also receive signals from an intermediary device, a remote control, speakers 28, etc. and the signals may leverage infrared, Bluetooth, WiFi, electromagnetic waves generally, or any other suitable transmission protocol for communicating data (e.g., potentially over a network) from one element to another. Virtually any control path can be leveraged in order to deliver information between video conferencing unit 38 and camera 22. Transmissions between these devices can be bidirectional in certain embodiments such that the devices can interact with each other. This would allow the devices to acknowledge transmissions from each other and offer feedback where appropriate. Any of these devices can be consolidated with each other or operate independently based on particular configuration needs. In one particular instance, camera 22 is intelligently powered using a USB cable. In a more specific example, video data is transmitted over an HDMI link and control data is communicated over a USB link.

Video conferencing unit 38 is a network element that can facilitate the collaborator representation activities discussed herein. As used herein in this Specification, the term ‘network element’ is meant to encompass any of the aforementioned elements, as well as routers, switches, cable boxes, gateways, bridges, loadbalancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, video conferencing unit 38 includes software to achieve (or to foster) the collaborator representation activities discussed herein. This could include the implementation of instances of participation representation module 40. Additionally, each of these elements can have an internal structure (e.g., a processor, a memory element, etc.) to facilitate some of the operations described herein. In other embodiments, these collaborator representation activities may be executed externally to these elements, or included in some other network element to achieve the intended functionality. Alternatively, video conferencing unit 38 may include software (or reciprocating software) that can coordinate with other network elements in order to achieve the collaborator representation activities described herein. In still other embodiments, one or several devices may include any suitable algorithms, hardware, software, components, modules, interfaces, or objects that facilitate the operations thereof.

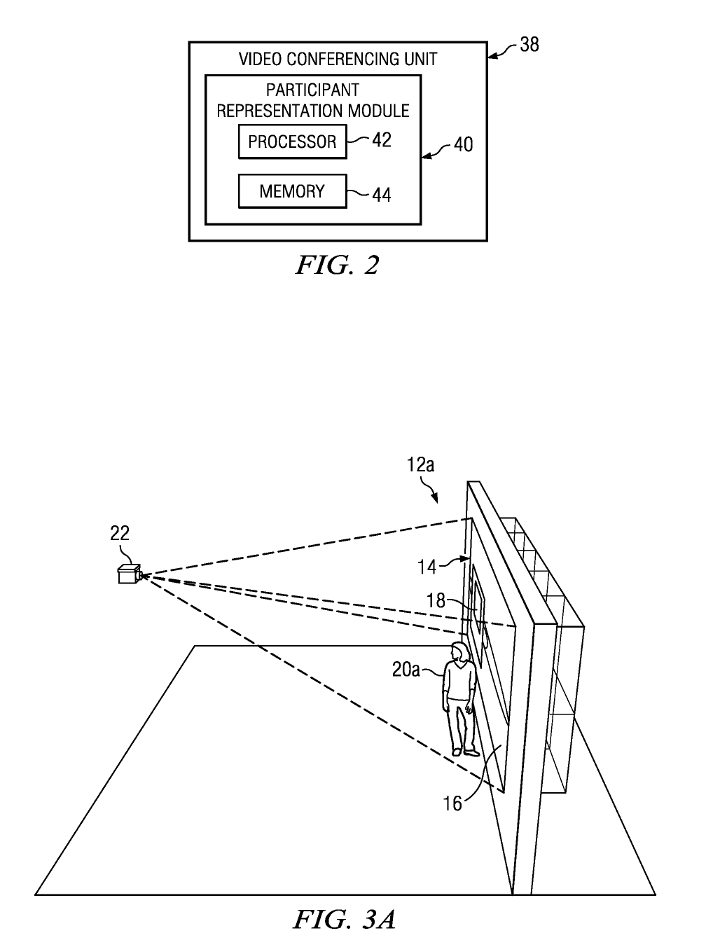

Turning to FIG. 2, FIG. 2 is a block diagram illustrating additional details associated with video conferencing unit 38. Video conferencing unit 38 includes participant representation module 40. Participant representation module 40 includes a processor 42 and a memory 44. In an embodiment, using shading and/or blending of collaborators according to the distance from display screen 14 to indicate the grade of presence, video conferencing unit 38 can project the collaborators onto a video stream and sent the video stream to other sites. In another embodiment, to avoid cascading, collaborators from each different site may be sent on a different stream to a remote receiver and the remote receiver can mix or combine the streams into a video stream. Each site may add a new layer to provide natural sharing of presentation area 12a.

More specifically, video conferencing unit 38 may calculate a difference image signal between the first image signal and the captured signal and generate a second image signal by respectively inserting pixel values of the first image signal in the corresponding pixel positions of the difference image signal, where the pixel values of the difference image signal are below a threshold. The difference image signal may then be used to create a collaboration area (e.g., presentation area 12a or 12b), which can be shared between conference sites. As a result, a natural and/or intuitively understandable representation of the collaborators working close to or on display screen 14 can be achieved.

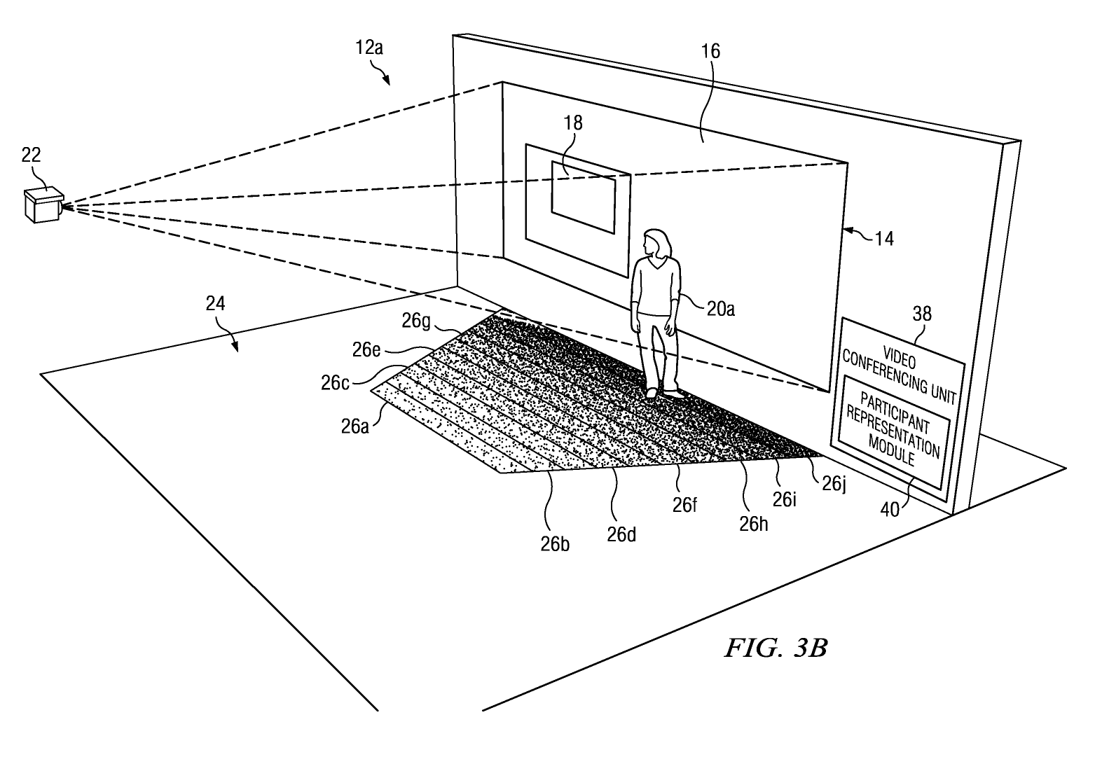

Turning to FIG. 3A, FIG. 3A is a schematic diagram illustrating additional details associated with collaboration system 10. FIG. 3A includes presentation area 12a, display screen 14, image 16, presentation material 18, collaborator 20a, and camera 22. FIG. 3A illustrates camera 22 capturing collaborator 20a in front of display screen 14. Collaboration system 10 may be configured to calculate a difference image signal between the first image signal (e.g., the image signal used for image 16) and a captured object/image signal (e.g., the image signal of collaborator 20a captured by camera 22) and generate a second image signal by respectively inserting pixel values of the first image signal in the corresponding pixel positions of the object/image signal where the pixel values of the object/image signal are below a threshold. The object/image signal may then be used to create an object signal for display which can be shared between presentation sites. The term ‘object/image signal’ is inclusive of any data segment associated with data of any display (local or remote), any presentation material, any collaborator data, or any other suitable information that may be relevant for rendering certain content for one or more participants.

Turning to FIG. 3B, FIG. 3B is a block diagram illustrating additional details associated with collaboration system 10. FIG. 3B includes presentation area 12a, display screen 14, image 16, presentation material 18, collaborator 20a, camera 22, floor 24, gradients 26a-j, and video conferencing unit 38. Video conferencing unit 38 includes participation representation module 40. Gradients 26a-j illustrate the opaqueness of a collaborator as they move closer to or further away from display screen 14. For example, at gradient 26a, collaborator 20a may be barely visible while at gradient 26g, collaborator 20a may be mostly visible, but still have some faint ghosting effects. Gradients 26a-j are for illustrative purposes and, in most examples, would not be visible on floor 24.

Collaboration system 10 can be configured for tracking the distance between collaborator 20a and display screen 14. In one example, in addition to capturing collaborator 20a, camera 22 also captures floor 24 behind collaborator 20a. By tracking of the feet position of collaborator 20a related to a lower edge of the camera picture, the distance to display screen 14 may be determined. In another example, only the floor area that is set as presentation area 12a is within the camera field. Persons with their feet fully within this area are identified as collaborators and thus fully visible in the collaboration act. In yet another example, a second camera could be present and knowing the distance between the two cameras and the distance to display screen 14 could make triangulation of a collaborator possible (e.g., the two camera pictures are compared and the shadow collaborator 20a casts on the wall can be used as reference).

After the distance between collaborator 20a and display screen 14 has been determined, collaboration system 10 can overlay and blend collaborators on top of image 16. The degree of blending can be used to simulate the grade of presence. For example, a collaborator in close interaction with presentation material 18 (e.g., editing or explaining presentation material 18) may be in gradient 26j and therefore shown as fully visible. A collaborator standing away from the presentation may be in gradient 26b and be shown as a transparent or outlined figure, similar to the ghost image in sports events or racing video games.

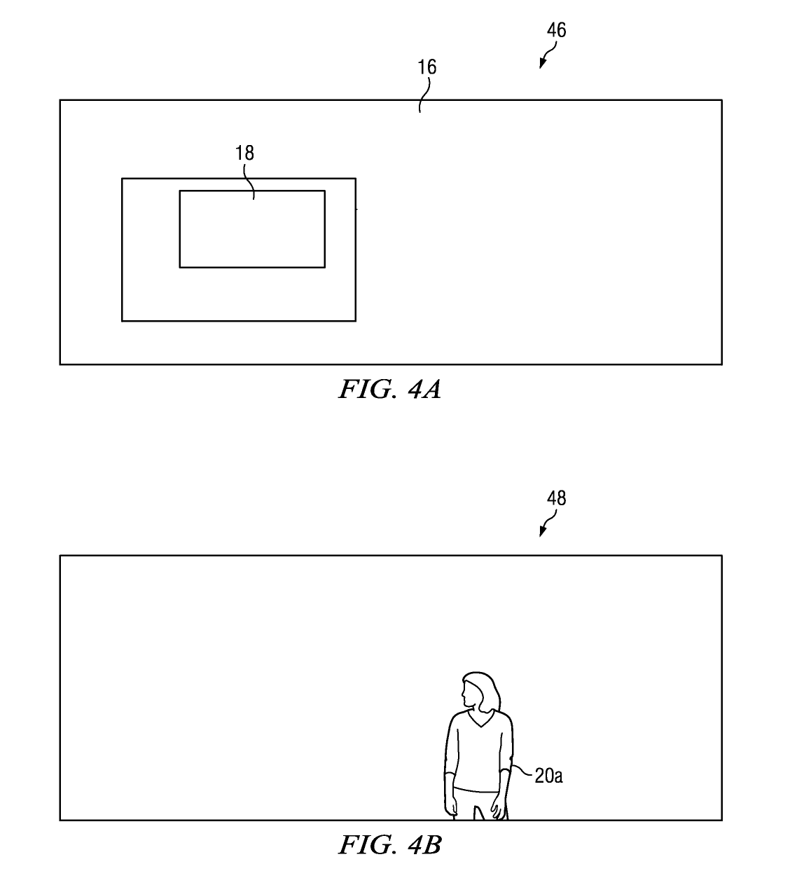

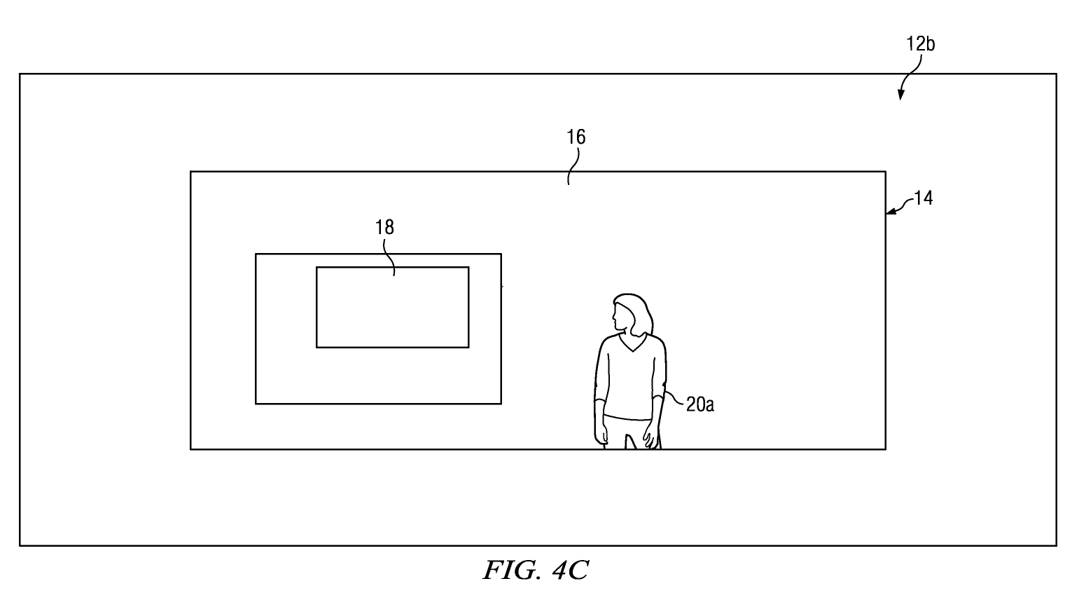

Turning to FIG. 4A, FIG. 4A is a block diagram illustrating additional details associated with collaboration system 10. FIG. 4A illustrates a first video signal 46 that may be communicated between local conference room 32a and remote conference rooms 32b and 32c. First video signal 46 includes image 16. Image 16 includes presentation material 18. Presentation material 18 may be a non-mirrored image of a chart, graph, white board, video, PowerPoint presentation, text document, etc.

Turning to FIG. 4B, FIG. 4B is a block diagram illustrating additional details associated with collaboration system 10. FIG. 4B illustrates a second video signal 48 that may be communicated between local conference room 32a to remote conference rooms 32b and 32c. Second video signal 48 includes a video of collaborator 20a that was captured in local conference room 12a. In an example, collaborator 20a was first captured on video in front of first video signal 46 and the captured video included first video signal 46. Video conferencing unit 38 removed first video signal 46 to create second video signal 48 that only includes collaborator 20a and not image 16 or presentation material 18.

Turning to FIG. 4C, FIG. 4C is a block diagram illustrating additional details associated with collaboration system 10. FIG. 4C illustrates the combination of first video signal 46 and second video signal 48, as displayed on remote sites. FIG. 4C includes display screen 14, image 16, presentation material 18, and collaborator 20a. By using first video signal 46 as a base image and then stacking second video signal 48 onto first video signal 46, collaborator 20a and other remote collaborators (e.g., collaborator 20d) can interact with presentation material 18 as if they were in the same room. In addition, multiple video signals of remote collaborators can be stacked onto first video signal to produce an interactive collaborative environment.

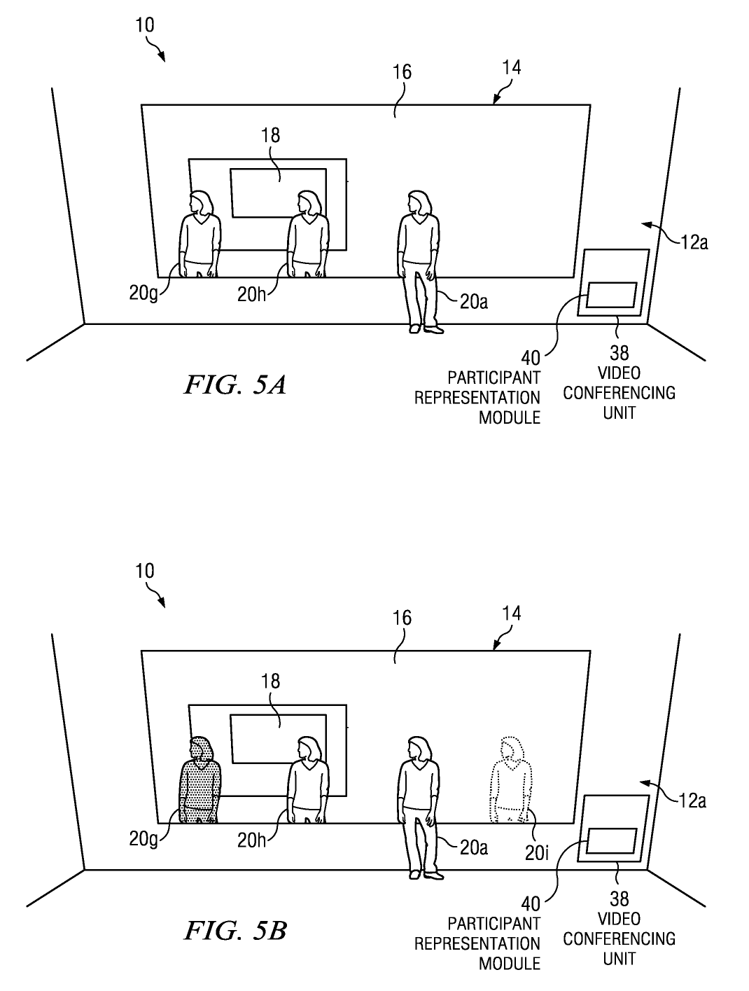

Turning to FIG. 5A, FIG. 5A includes presentation area 12a. Presentation area 12a includes display screen 14, collaborator 20a, and video conferencing unit 38. Video conferencing unit 38 includes participation representation module 40. Display screen 14 includes image 16. Image 16 includes presentation material 18 and collaborators 20g and 20h. In one example, collaborator 20g is located in remote conference room 32b and collaborator 20h is located in remote conference room 32c. In one illustrative example, to obtain the image shown in FIG. 5A an object signal (similar to the video signal illustrated in FIG. 4B) was sent from remote conference room 32b that contained a video of collaborator 20g. Similarly, a second object signal was sent from remote conference room 32c that contained a video of collaborator 20h. Video conferencing unit 38 then combined the two object signals with a first video signal (similar to the one illustrated in FIG. 4A) that contains image 16 and presentation material 18 to produce the image displayed on display screen 14. Collaborators 20a, 20g, and 20h can interact with presentation material 18 as if they were in the same room.

Turning to FIG. 5B, FIG. 5B includes presentation area 12a. Presentation area 12a includes display screen 14, collaborator 20a, and video conferencing unit 38. Video conferencing unit 38 includes participation representation module 40. Display screen 14 includes image 16. Image 16 includes presentation material 18, and collaborators 20g, 20h, and 20i. In one example, collaborator 20g is located in remote conference room 32b and collaborators 20h and 20i are located in remote conference room 32c. Collaborator 20i may have just walked into remote conference room 32c and thus is relatively far from the presentation area in remote conference room 32c. As a result, collaborator 20i is ghosted or not very opaque. However, collaborator 20g may be very close to presentation area 12b (e.g., she is giving a presentation and may be focusing in on something specific in presentation material 18) and therefore she is show as being opaque. In addition, collaborator 20h in remote conference room 32c may be off to the side or a little bit away from presentation material 18 while collaborator 20g is discussing something about presentation material 18 and therefore is not as opaque as collaborator 20g, but more opaque than collaborator 20i who is further away.

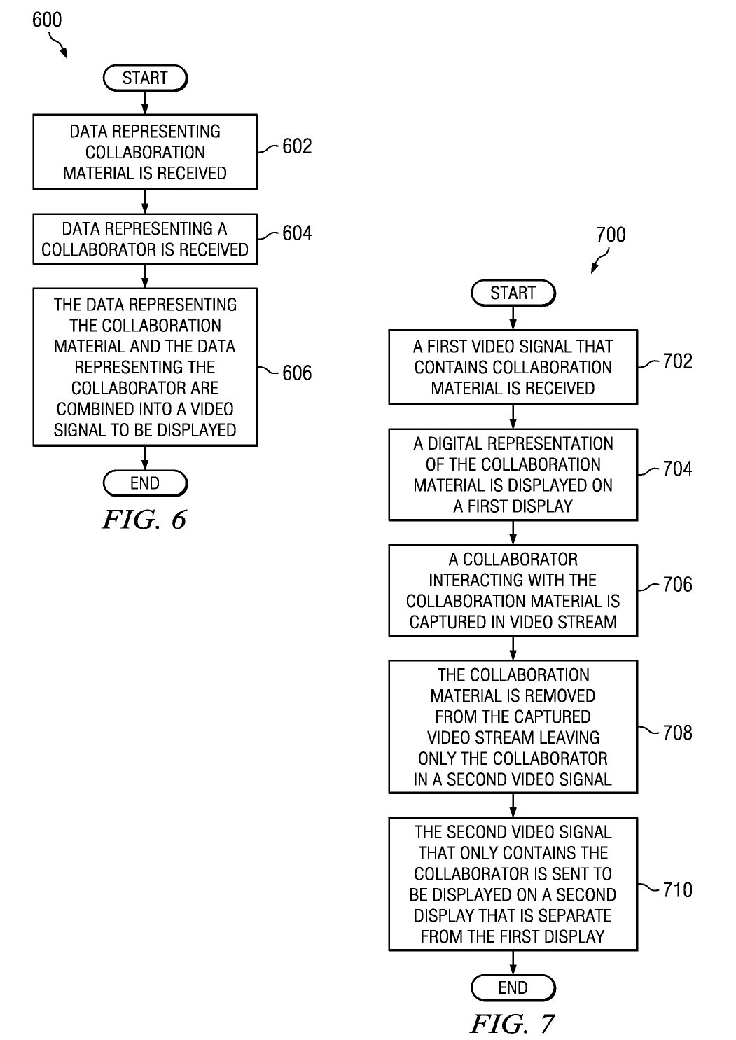

Turning to FIG. 6, FIG. 6 is a simplified flowchart 600 illustrating one potential operation associated with the present disclosure. At 602, data representing collaboration material is received. At 604, data representing a collaborator is received. At 606, the data representing the collaboration material and the data representing the collaborator are combined into a video signal (an object/image signal) to be displayed.

Turning to FIG. 7, FIG. 7 is a simplified flowchart 700 illustrating one potential operation associated with the present disclosure. At 702, a first video signal that contains collaboration material is received. At 704, a digital representation of the collaboration material is displayed on a first display. At 706, a collaborator interacting with the collaboration material is captured in a video stream. At 708, the collaboration material is removed from the captured video stream leaving only the collaborator in a second video signal. At 710, the second video signal that only contains the collaborator is sent to be displayed on a second display that is separate from the first display.

As identified previously, a network element (e.g., video conferencing unit 38) can include software to achieve the collaborator representation operations, as outlined herein in this document. In certain example implementations, the collaborator representation functions outlined herein may be implemented by logic encoded in one or more tangible, non-transitory media (e.g., embedded logic provided in an application specific integrated circuit [ASIC], digital signal processor [DSP] instructions, software [potentially inclusive of object code and source code] to be executed by a processor [processor 42 shown in FIG. 2], or other similar machine, etc.). In some of these instances, a memory element [memory 44 shown in FIG. 2] can store data used for the operations described herein. This includes the memory element being able to store software, logic, code, or processor instructions that are executed to carry out the activities described in this Specification.

The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the collaborator representation activities as outlined herein. Additionally, each of these devices may include a processor that can execute software or an algorithm to perform the collaborator representation activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein can be construed as being encompassed within the broad term ‘memory element.’ Similarly, any of the potential processing elements, modules, and machines described in this Specification can be construed as being encompassed within the broad term ‘processor.’ Each of the network elements can also include suitable interfaces for receiving, transmitting, and/or otherwise communicating data or information in a network environment.

Note that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It can be appreciated that collaboration system 10 (and its teachings) are readily scalable and, further, can accommodate a large number of components, as well as more complicated/sophisticated arrangements and configurations. Accordingly, the examples provided should not limit the scope or inhibit the broad teachings of collaboration system 10, as potentially applied to a myriad of other architectures.

It is also important to note that the steps in the preceding FIGURES illustrate only some of the possible scenarios that may be executed by, or within, collaboration system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by collaboration system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain protocols (e.g., TCP/IP, UDP, SSL, SNMP, etc.), collaboration system 10 may be applicable to any other exchanges and protocols in which data are exchanged in order to provide collaborator representation operations. In addition, although collaboration system 10 has been illustrated with reference to particular elements and operations that facilitate the communication process, these elements and operations may be replaced by any suitable architecture or process that achieves the intended functionality of collaboration system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
displaying a first image signal on a screen;
capturing an object in front of the screen in a captured object/image signal; and
generating an object signal by removing the first image signal from the object/image signal, wherein the object signal is a representation of the object captured in front of the screen.

2. The method of claim 1, wherein the object signal is generated by respectively inserting pixel values of the first image signal in corresponding pixel positions of the object/image signal, wherein a difference between the pixel values of the first image signal and the corresponding pixel positions of the object/image signal are below a threshold.

3. The method of claim 1, further comprising:
spatially aligning the first image signal and the object/image signal by associating pixel positions of the first image signal and the object/image signal.

4. The method of claim 1, further comprising:
assigning a gradient to the representation of the object in the object signal, wherein the gradient is based on a detected distance from the object to the screen.

5. The method of claim 1, wherein the screen is a first video conference screen, the method further comprising:
sending the object signal to a second video conference screen that is remote from the first video conference screen;
combining the object signal and the first image signal to create a remote object/image signal; and
displaying the remote object/image signal on the second video conference screen.

6. The method of claim 5, further comprising:
receiving a second object signal;
combining the second object signal and the remote object/image signal to create a second remote object/image signal; and
displaying the second remote object/image signal on the second video conference screen.

7. The method of claim 1, wherein the first image signal is a non-mirrored representation of collaboration material and the object is a collaborator.

8. Logic encoded in non-transitory media that includes instructions for execution and when executed by a processor, is operable to perform operations comprising:
displaying a first image signal on a screen;
capturing an object in front of the screen in a captured object/image signal; and
generating an object signal by removing the first image signal from the object/image signal, wherein the object signal is a representation of the object captured in front of the screen.

9. The logic of claim 8, wherein the object signal is generated by respectively inserting pixel values of the first image signal in corresponding pixel positions of the object/image signal, wherein a difference between the pixel values of the first image signal and the corresponding pixel positions of the object/image signal are below a threshold.

10. The logic of claim 8, the operations further comprising:
spatially aligning the first image signal and the object/image signal by associating pixel positions of the first image signal and the object/image signal.

11. The logic of claim 8, the operations further comprising:
assigning a gradient to the representation of the object in the object signal, wherein the gradient is based on a detected distance from the object to the screen.

12. The logic of claim 8, wherein the screen is a first video conference screen, the operations further comprising:
sending the object signal to a second video conference screen that is remote from the first video conference screen;
combining the object signal and the first image signal to create a remote object/image signal; and
displaying the remote object/image signal on the second video conference screen.

13. The logic of claim 12, the operations further comprising:
receiving a second object signal;
combining the second object signal and the remote object/image signal to create a second remote object/image signal; and
displaying the second remote object/image signal on the second video conference screen.

14. The logic of claim 8, wherein the first image signal is a non-mirrored representation of collaboration material and the object is a collaborator.

15. An apparatus, comprising:
a memory element for storing data;
a processor that executes instructions associated with the data; and
a presentation module configured to interface with the processor and the memory element such that the apparatus is configured to:
display a first image signal on a screen;
capture an object in front of the screen in a captured object/image signal; and
generate an object signal by removing the first image signal from the object/image signal, wherein the object signal is a representation of the object captured in front of the screen.

16. The apparatus of claim 15, wherein the object signal is generated by respectively inserting pixel values of the first image signal in corresponding pixel positions of the object/image signal, wherein a difference between the pixel values of the first image signal and the corresponding pixel positions of the object/image signal are below a threshold.

17. The apparatus of claim 15, wherein the apparatus is further configured to:
spatially align the first image signal and the object/image signal by associating pixel positions of the first image signal and the object/image signal.

18. The apparatus of claim 15, wherein the apparatus is further configured to:
assign a gradient to the representation of the object in the object signal, wherein the gradient is based on a detected distance from the object to the screen.

19. The apparatus of claim 15, wherein the screen is a first video conference screen, and the apparatus is further configured to:
send the object signal to a second video conference screen that is remote from the first video conference screen;
combine the object signal and the first image signal to create a remote object/image signal; and
display the remote object/image signal on the second video conference screen.

20. The apparatus of claim 15, wherein the first image signal is a non-mirrored representation of collaboration material and the object is a collaborator.
